(19) United States
(12) Patent Application Publication
(10) Pub. No.: US 2013/0103596 A1
(43) Pub. Date: Apr. 25, 2013

(54) DENOMINATED AUTHENTICATING ROYALTY COLLECTION AND ENFORCEMENT PROCESS

(71) Applicant: Sabre Publishing, Ltd. Co. d/b/a Sabre Trademark, Duncan, OK (US)

(72) Inventors: Shay Hayes, Foster, OK (US); Susan McNair, Marlow, OK (US); John Bachelor, Duncan, OK (US)

(73) Assignee: Sabre Publishing, Ltd. Co. d/b/a Sabre Trademark & Licensing, Ltd. Co., Duncan, OK (US)

(21) Appl. No.: 13/655,729

(22) Filed: Oct. 19, 2012

Related U.S. Application Data
(60) Provisional application No. 61/550,773, filed on Oct. 24, 2011.

(51) Int. Cl. G06Q 99/00

(52) U.S. Cl. 705/310; 705/318

(57) ABSTRACT

A denominated authenticating royalty collection and enforcement system and process. The invention includes a data generation process including creation and assignment of a plurality of product category values. A process is provided to manufacture anti-fraud tags for merchandise. One or more merchandise vendors for the merchandise are licensed under the process. Royalties are collected from the licensed merchandise vendors. The process includes the steps of supplying secure tags and authenticating the supply of the secure tags. Additionally, a procedure is provided for the public, licensees, licensor and others to visually authenticate that an appropriate royalty has been paid for a particular product or products.

### CROSS REFERENCE

This application is based on and claims priority to U.S. Provisional Patent Application Ser. No. 61/550,773, which was filed on Oct. 24, 2011.

### BACKGROUND OF THE INVENTION

1. Field of the Invention

The present invention relates to the field of implementing and managing an entire merchandise licensing process from including but not limited to licensing, collecting, authenticating, and enforcing the authorized use of a licensor's trademarks, brands or logos (hereinafter “Marks”). Specifically, the present invention is a process and system that utilizes a combination of existing technology to make the necessary steps in royalty management (licensing, collecting, authenticating, and enforcing) economical and feasible on a micro or macro level for both large sized and small sized licensors to both large sized and small sized licensees.

2. Prior Art

Historically, colleges and professional sports teams have capitalized on their trademarks, brands and logos by registering their trademarks and licensing the use thereof, either themselves or through a licensing agent.

To date, the model typically utilized for college and professional sports logo licensing has not served the needs of high schools or primary education markets because these markets differ significantly from the college and/or professional market in several ways.

First, in overall retail sales, the high school market is half the size of the U.S. college market at approximately $2 billion a year. There are approximately 18,500 high schools in the United States serving approximately 14,370,000 students nationwide.

Secondly, enforcement and collection of a high school logo licensing program require unique protocols compared to the college and/or professional model.

In many cases, high school merchandise is often times produced and sold to the public by small, locally owned, independent retail shops. This requires licensing and collection of the royalty directly from the retailer instead of the manufacturer. It also results in many more licensed entities that must be tracked.

The model used at the college and/or professional level which requires a lengthy approval process for authorized manufacturers and extensive audits of beginning and ending inventory levels for royalty payments calculations, and extensive field audits and enforcement units cannot economically be utilized at the high school level.

At the college and/or professional level, licensing agents have an army of enforcement agents that monitor and audit the sale of licensed merchandise in all the major university cities and retail outlets. In addition, many major universities have an enforcement department that works with licensing agents to identify unlicensed use of its logo.

Conventional collegiate licensing agents utilize technology in the form of a counterfeit proof hologram required to be attached to all licensed merchandise to identify it as authentic.

When violations of the licensing policy are reported, these agents prosecute the enforcement with a team of in-house attorneys in conjunction with university counsel.

At the high school level, the schools cannot afford enforcement officers or legal fees associated with enforcement, and a licensing agent cannot afford the multiple number of enforcement agents necessary to monitor all the locally owned retail shops in the nation.

The college/professional model of royalty collection relies on license contracts with the major manufacturers of merchandise. Current licensing programs focus on the manufacturing community and fail to accommodate royalty collection at other levels such as distribution or retail.

The manufacturers enter the contract and then account for all sales annually and pay the royalty due. This requires extensive audits of the manufacturers' verification of accounting.

At the high school level, the collegiate and/or professional type inventory and accounting requirements for the retailers are too strenuous to be economically implemented. Furthermore, the auditing task of auditing the multitude of local retail establishments producing and selling high school merchandise would be unmanageable for a school or their licensing agent.

To date, companies entering the high school market have tried without success to implement a licensing program based on the college model.

In order to successfully implement a high school licensing program, a licensing, collection, authentication, and enforcement mechanism must be utilized that is more efficient than the college and/or professional model. Not only does the model have to be user friendly to the local retail shops paying the royalty, but it must also be easy to track and enforce by the licensor.

In light of the deficiencies that exist in the conventional forms of licensing and royalty management methods, a heretofore unaddressed need exists in the market.

Licensing programs intended to enforce royalty collection are currently used in multiple industries. These programs utilize a hologram or hangtag device in an attempt to authenticate to the public that the merchandise is authorized product or product that has paid appropriate royalties.

However, the current use of these types of holograms or hangtags does not allow the public or the consumer to self-authenticate the fact that a product bearing the hangtag or hologram has actually paid the appropriate amount of royalty to the appropriate party.

The current use of these holographic devices can only prevent fraud or pirated merchandise if the consumer is familiar enough with the “real” hologram to recognize a fake hologram. This leaves enforcement of the royalty to professionals employed by the licensor or their agent to inspect and verify merchandise in the stream of commerce.

More importantly, there is currently no use of a hangtag that shows the denominated price point that a product is authorized to be sold for or a hangtag that utilizes 2d matrix code technology to direct a consumer to information that authenticates the timing and amount of actual royalty paid on that product.

The present invention utilizes a combination of multiple existing technologies that results in a process that not only authorizes the licensee's use of trademarks and logos in a user friendly way, but also tracks the collection of the appropriate royalty amount through a prepaid system, and provides a self-authenticating mechanism of “s-tags” that are denominated, and imbedded with codes that allow the public to confirm that each product has been properly licensed and has paid the appropriate royalty for its retail price point.

The present invention allows the burden of enforcement of royalty collection to be shared by a large community of stake holders including the licensor, the licensor's agent, and the licensor's stake holders (which in the case of schools includes but is not limited to faculty, staff, parents, students, coaches, athletes, alumni, and others).

The present invention employs the use of a counterfeit proof merchandise hang tag (called a secure tag or S-Tag) that has multiple features to facilitate the licensing process, the collection process, the authentication process, and the enforcement process.

The S-Tags and the proprietary Licensing Software Platform Modules aid the efficiency of the licensing process that can be entirely accomplished online.

The S-Tags issued in specific denominations and the royalty imposed on a price point basis aid the collection process by serving as both an inventory mechanism and an accounting mechanism for the royalty collection process.

The S-Tags with their official insignia and serial numbers and denominations and barcode technology aid the consumers and the public in the authentication process of officially licensed products.

With community awareness in every high school community that utilizes the present invention, the students, the parents, the alumni, the teachers, the coaches, the authorized vendors, and the entire community can assist in the enforcement process, thereby relieving the need for massive enforcement units or extensive audits.

Conventional models of licensing have long used hang tags for authentication and enforcement purposes, but in addition to harnessing the counterfeit proof hang tags for authentication/enforcement purposes, the present invention uses the S-Tags to serve as the collection and accounting mechanism.

When licensees, whether they are retailers or manufacturers, are licensed to sell merchandise by a licensor or their agent, the licensee can order the number of S-Tags they desire for the amount of products they wish to sell.

In effect they “pre-pay’ the royalty by “buying” the appropriately denominated S-Tag for each product they desire to sell.

The S-Tag serves as an inventory item that tracks royalty collected as well as an authentication item to the public.

In the present invention, there are multiple denominations of S-Tags available for different price brackets or Product Category Values of products.

By way of example, if a licensee wants to produce and sell one hundred $10 T-shirts, they simply have to order one hundred “$10.00” S-Tags from the licensor for $1 each (assuming a 10% royalty rate).

When the licensee receives S-Tags from the licensor or their agent, they attach the S-Tags to the merchandise they are selling to authenticate to the public that the royalty has already been “pre-paid” through the purchase of the S-Tags. Thus, there will be no accounting or collection problems to worry about with the present invention.

The present invention will work very simply at the retail level for small local shops that order or produce their own product for retail.

If larger retail outlets do not desire to order and affix the S-Tags, the present invention will work equally well at the manufacturer, or distributor or wholesale supplier level.

When the manufacturer, distributor or wholesale supplier has already paid the royalty on a product and attached the S-Tag, then the retailer need not worry about any licensing issues because the royalty only has to be paid once for every item sold in the stream of commerce.

The end result is that all merchandise purchased by the public, whether it comes from online stores, local retail shops, or large retail outlets, should be officially licensed product that has the official counterfeit-proof S-Tags attached proving that the licensing royalty has been paid through the process of the present invention.

### SUMMARY OF THE INVENTION

The present invention provides for a comprehensive licensing and royalty management process that utilizes a combination of existing technology to make each of the licensing, collecting, authenticating, and enforcing steps economically feasible.

The process utilizes a proprietary software program (the “Licensing Software Platform” or “LSP”) that in one preferred embodiment has two modules—a first Module 1 which generates the necessary tracking data for authenticating and enforcing and a second Module 2 which interacts with the licensee and automates the licensing and collection process.

The process also involves a specific data generation procedure and a specific manufacture or printing procedure for secure identification tags (“S-Tags”) which are used in the authenticating procedure.

During the licensing procedure, licensees who desire to utilize the Marks of a licensor agree to the terms of the licensing agreement and become authorized licensees.

During the collecting procedure, licensors or their agent receive the appropriate royalty payments from the authorized licensees.

During the authenticating procedure, the licensors provide an identifying device for the licensee to attach to the merchandise that bears licensors' Marks.

During the enforcement process, the licensor (with the assistance of other stakeholders such as the licensor's agent, other authorized licensees, the consumers, and the community as a whole) monitor and manage the royalty and ensure compliance on the part of licensees and/or unlicensed parties.

### BRIEF DESCRIPTION OF THE DRAWINGS

FIG. 1 is an example of a computer screen shot within a first software module—Module 1—showing creation of product category values (PCV) categories and the user to manage them according to the present invention.

FIG. 2 is a computer screen shot within Module 1 showing creation of the PCV for the categories.

FIG. 3 is a computer screen shot within Module 1 showing creation of Serial Numbers for the PCV.

FIG. 4 is a computer screen shot within Module 1 showing creation of 2D Matrix Barcodes.

FIG. 5 is a computer screen shot within Module 1 showing creation of a zip file to download and print the S-Tags.

FIG. 6 is a computer screen shot within Module 1 showing a data entry process to validate or enter a licensee.

FIG. 7 is a computer screen shot within Module 1 showing the data entry process to assign a licensee to a licensor and assign PCVs to the transaction.

FIG. 8 is a computer screen shot within Module 1 showing the data entry process to add the PCV and assign S-Tags to the transaction.

FIG. 9 is a computer screen shot within Module 1 showing transaction details of an activated S-Tag resulting when a consumer scans the 2D Matrix Barcode during the enforcement process.

FIG. 10 is a computer screen shot within Module 1 showing a Not Authorized for Resale page resulting when the consumer scans the 2D Matrix Barcode during the enforcement process of an S-Tag that has not been activated or authorized for sale.

FIG. 11 shows an example of a front design and features of the S-Tag.

FIG. 12 shows an example of a back design and features of the S-Tag.

FIG. 13 is an example of a screen shot within a second software module—Module 2—showing creation and assignment of the PCV.

FIG. 14 is a computer screen shot within Module 2 illustrating and showing assignment of authorized images.

FIG. 15 is a computer screen shot within Module 2 illustrating and showing the licensee selecting the desired license, the PCV, description of manufactured product, and the quantity.

FIG. 16 is a computer screen shot within Module 2 showing a summary of items selected by the licensee before accepting the licensing terms and processing payment.

FIG. 17 is a computer screen shot within Module 2 showing the licensee login page or account creation.

FIG. 18 is a computer screen shot within Module 2 showing the licensee address options.

FIG. 19 is a computer screen shot within Module 2 showing the licensee selecting the shipping options for the S-Tags.

FIG. 20 is a computer screen shot within Module 2 showing the licensee selecting the payment options, order instructions, terms and conditions.

FIG. 21 is a computer screen shot within Module 2 showing the licensee payment when using credit cards.

FIG. 22 is a computer screen shot within Module 2 showing the order details of the licensee. With this information we process the transaction to activate and ship S-Tags in Module

FIG. 23 is a flowchart showing an example of the overall process of the present invention.

FIG. 24 is a flowchart showing an example of the data generation process in Module 1.

FIG. 25 is a flowchart showing an example of the S-Tag manufacturing process.

FIG. 26 is a flowchart showing an example of the licensing procedure process in Module

FIG. 27 is a flowchart showing an example of the collection procedure in Module 2.

FIG. 28 is a flowchart showing an example of the authentication procedure in Module 1.

FIG. 29 is a flowchart showing an example of the enforcement procedure.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

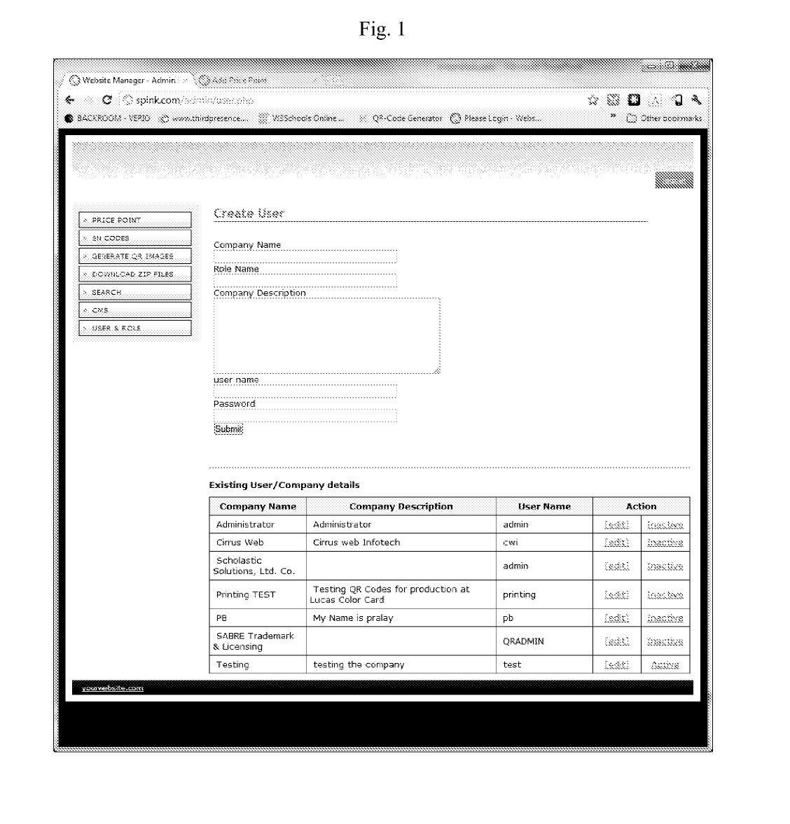

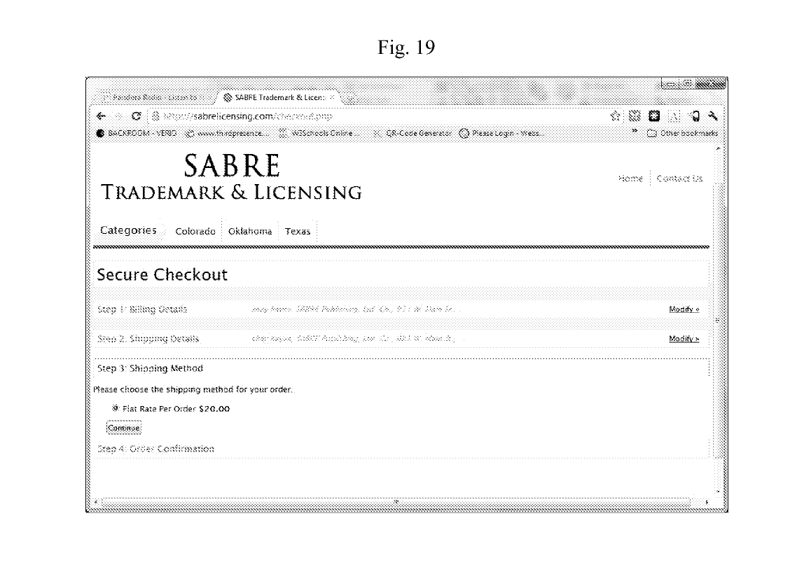

Referring to the drawings in detail, FIGS. 1 through 22 illustrate computer display screen shots showing various aspects of a preferred embodiment or embodiments of the process or system of the present invention. In the preferred embodiment described herein, two separate software modules are utilized, although, it will be understood that a single module or multiple modules may be utilized within the spirit and scope of the present invention.

The present invention may be accomplished by use of a database or databases operating with computer software programs and a central processing unit.

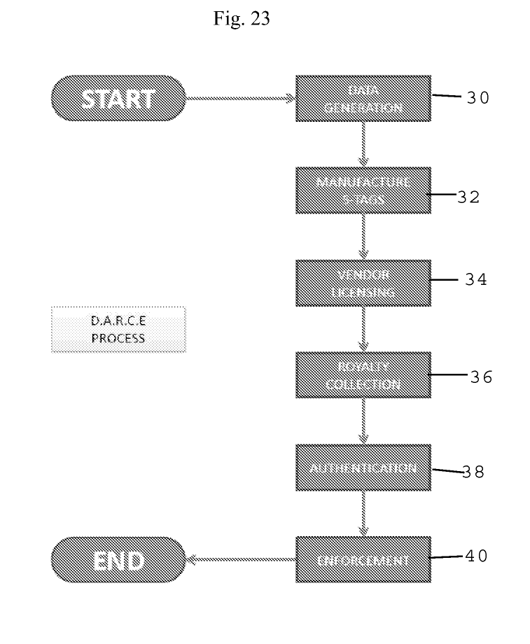

FIG. 23 illustrates a simplified sequential flowchart of six distinct processes or mechanisms which are utilized as a part of the present invention. Initially, a data generation procedure is employed as seen at box 30. Thereafter, a series of secure tags are manufactured as seen at box 32. The vendor or vendors are licensed to utilize the process as seen at box 34. A royalty collection procedure is employed as seen at box 36. An authentication process is incorporated as a part of the system as seen at box 38 as well as an enforcement process as seen at box 40.

Although the processes or mechanisms are shown in a sequential order, other sequences are possible within the spirit and scope of the invention.

### Data Generation Procedure

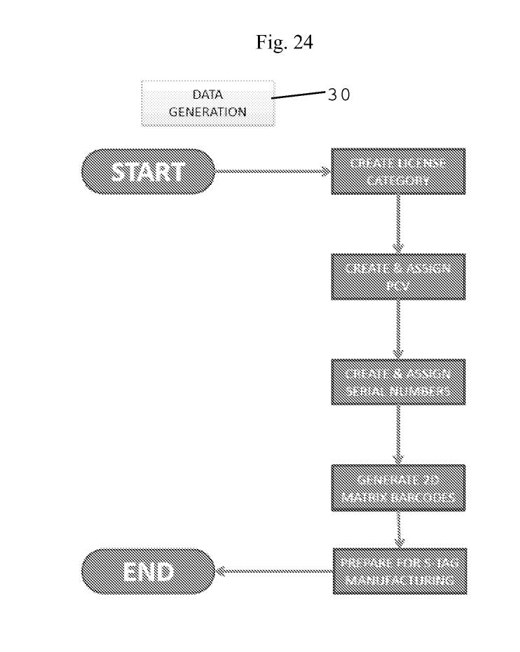

FIG. 24 is a simplified flow chart of the initial data generation procedure or mechanism 30.

1. As seen in FIG. 1, a specific licensing category (such as high school, collegiate, professional, or corporate) is created within Module 1 of the licensing software platform (LSP).

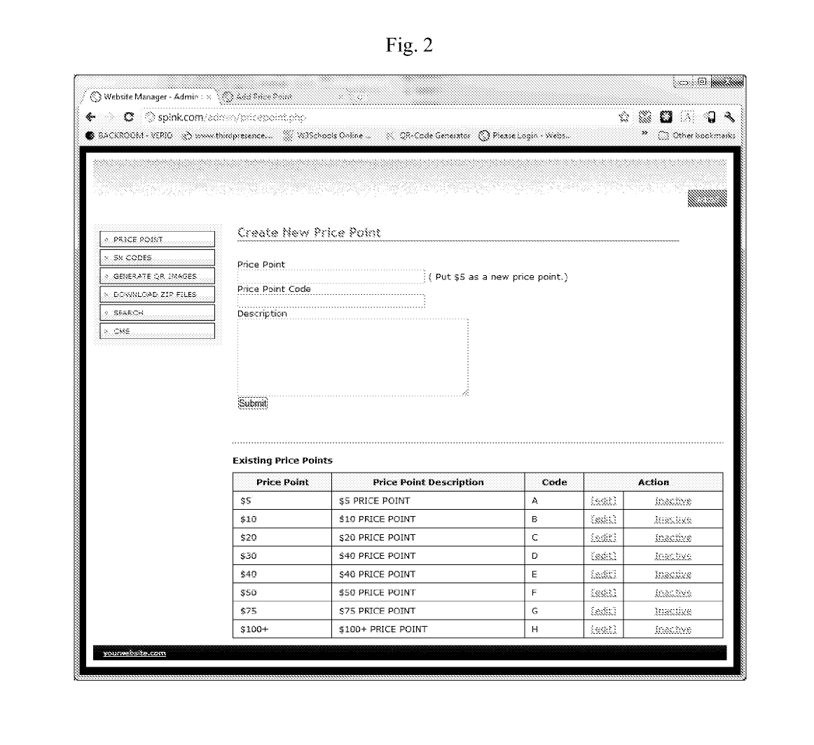

2. As seen in FIG. 2, Module 1 of the LSP is utilized to create and assign Product Category Values (“PCV”) for that specific licensing category by entering the price points at which the appropriate royalty will be assessed. The price points are brackets which cover a range of selling prices. For example, 0 to $5.00 is one price point bracket and $5.00 to $10.00 is another price point bracket. It will be appreciated that other price point brackets may be utilized.

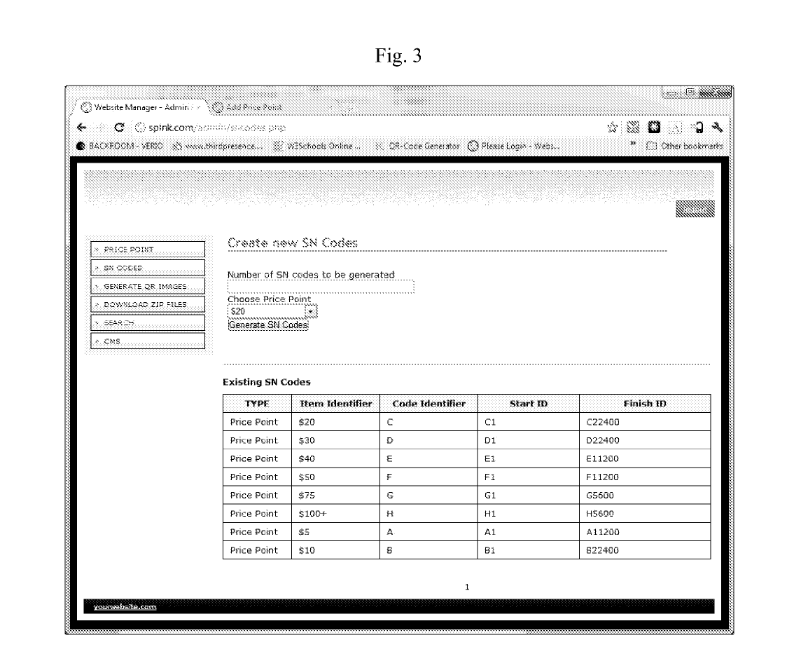

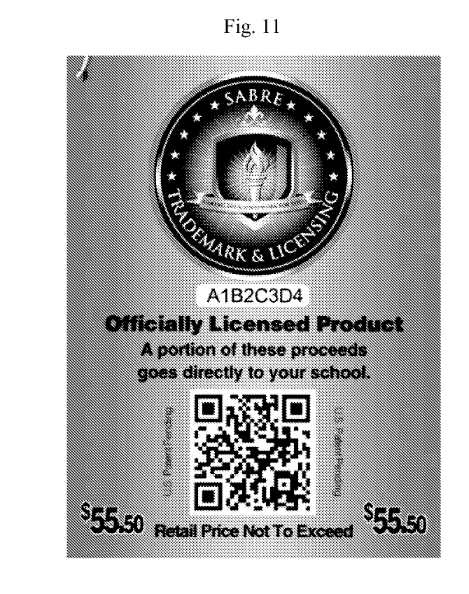

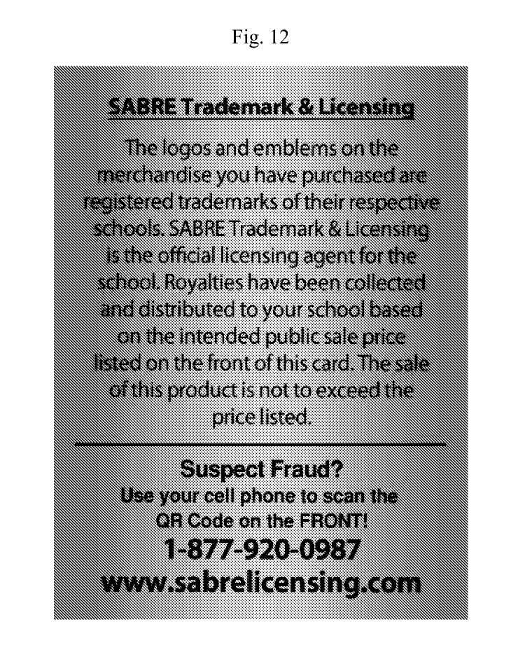

3. As seen in FIG. 3, Module 1 of the LSP is utilized to create a table of randomly generated 8-digit, case sensitive, alpha-numeric serial numbers that will be printed on each individual S-Tag (see FIGS. 11 and 12) that is ultimately attached to authorized merchandise to authenticate to the public that the appropriate royalty has been paid. Module 1 of the LSP will also assign a sequential ID number to each randomly produced serial number and list that sequential ID number in the table next to each randomly generated serial number. Different sizes, combinations and variations for serial numbers might be employed.

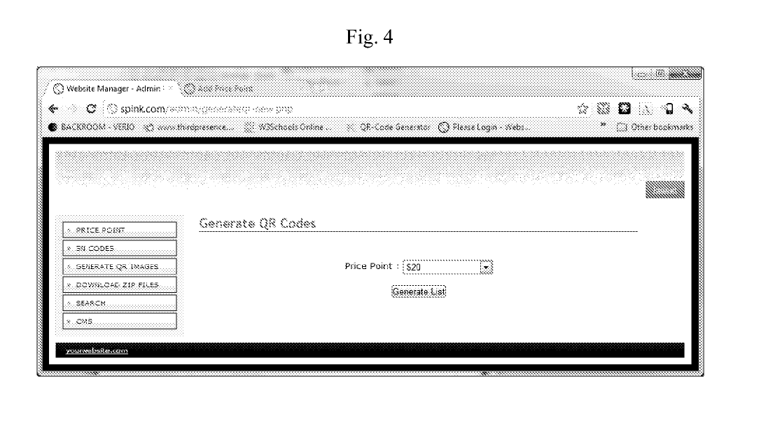

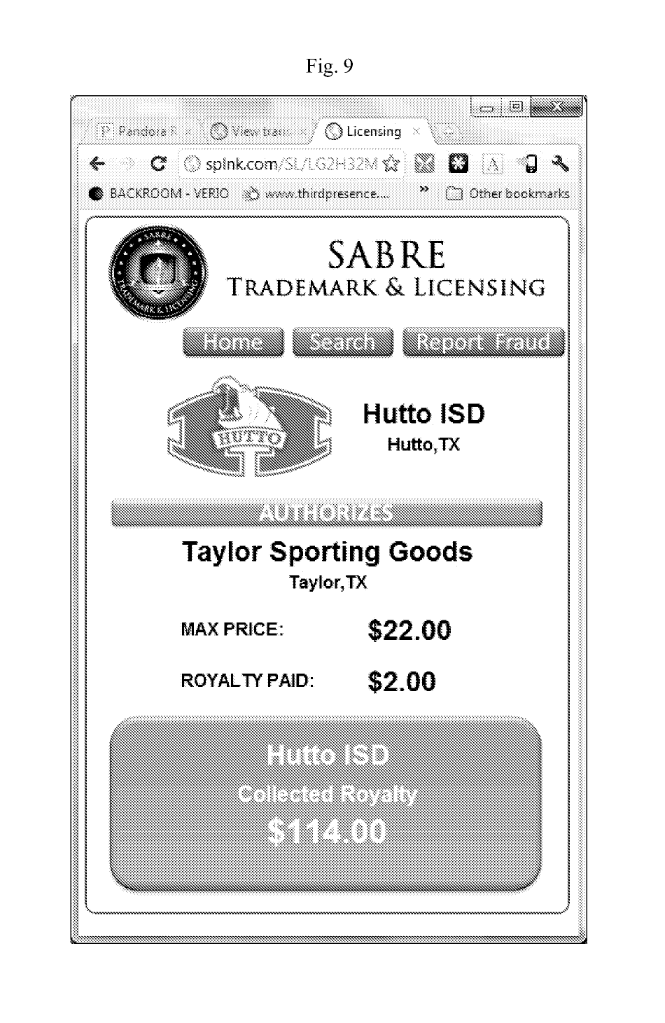

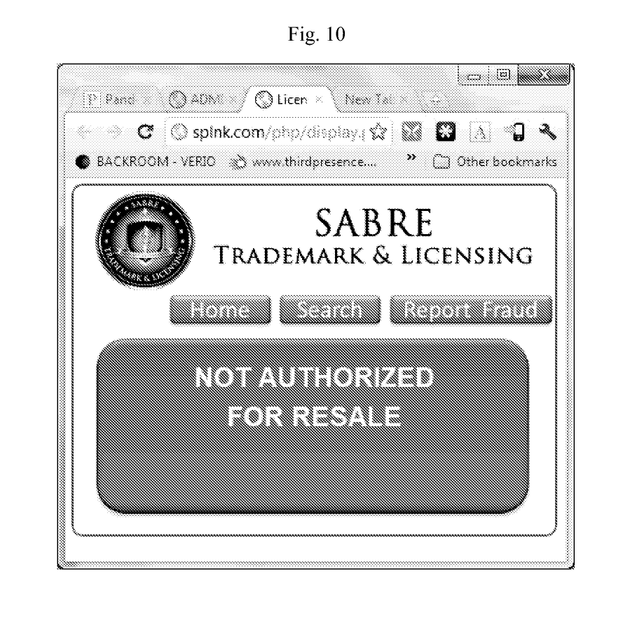

4. As seen in FIG. 4, Module 1 of the LSP is utilized to generate a population of 2D matrix barcode images (“Barcode”) which are based on and associated with the table of serial numbers. Each unique Barcode is associated with a unique serial number from the table. Using the standard 2D Matrix Barcode technology, the Barcode will contain a string of text that includes the associated Serial Number from the table to form a unique URL that queries (FIGS. 9 and 10) Module 1 of the LSP requesting specific transactional information on any transactions that are linked to specific serial number associated with that specific Barcode. This technology allows those transactional details (FIGS. 9 and 10) to be displayed on a web page and viewed with a web enabled device (for example, a smart phone, i Phone, Android, tablet, etc. . . . ). The 2D Matrix Barcode Technology might include QR codes, Microsoft tags, Aztec codes or others.

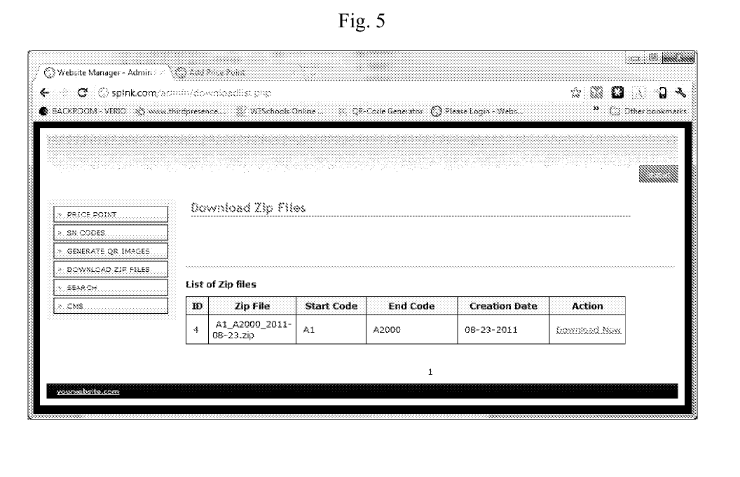

5. As seen in FIG. 5, Module 1 of the LSP is utilized to generate an export file that is used in the manufacturing of the S-Tag. A report is run on the table according to the selected PCV value and an Excel document or other spreadsheet is created and temporarily stored on the server. The Excel document consists of the Random Serial Number, Serial Number ID, the URL Query String based on the Serial number and the 2D Matrix Barcode file name associated with the Serial Number. Module 1 of the LSP will then gather all of the 2D Matrix Barcode image files and place them in the same location on the server as the excel file. Module 1 of the LSP will then compress all of the files into a single zip file and make them available for download via a URL on the page.

### Tag Manufacture Process

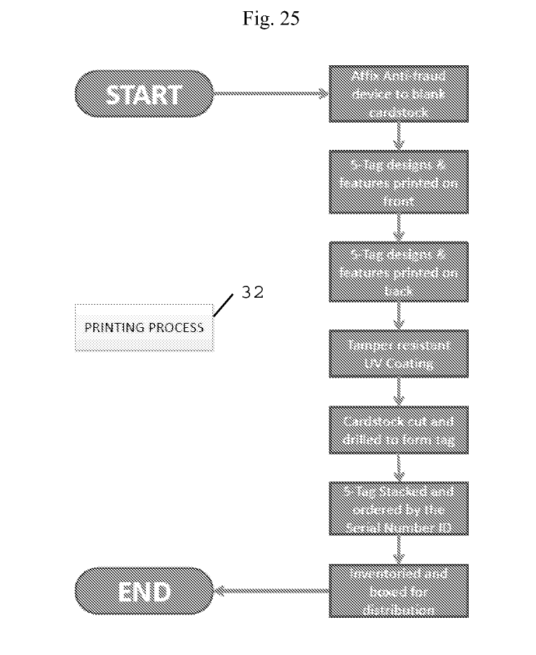

FIG. 25 is a simplified flow chart of the process or mechanism for production of a series of secure tags 32.

1. Blank sheets of paper or other material are affixed with an anti-fraud device by foil stamping or imbedding a hologram. Other or additional types of security devices might be employed within the spirit and scope of the invention.

2. The sheets are then printed with the general design (see FIGS. 11 and 12) of the S-Tag which includes the following features or elements:
a. A randomly assigned serial number from the table in Module 1 of the LSP,
b. The 2D Matrix Barcode image associated with the printed serial number and containing the URL to query Module 1 based on the associated serial number, and
c. A denominated dollar amount of the amount clearly visible on the S-Tag which corresponds to the maximum authorized retail sales price associated with the PCV assigned by Module 1 of the LSP.

3. The sheets are then coated with a tamper resistant ultraviolet (UV) coating.

4. The sheets are then cut into rows of S-Tags (see FIGS. 11 and 12), hole punched if needed, cut to final sizing, and stacked in sequential order, serial number by serial number, according to the sequential serial number ID's which are assigned by Module 1 of the LSP and listed in the table.

5. The ordered stacks of S-Tags are then inventoried in ordered rows awaiting distribution by the licensor or their agent.

As an optional alternative, the S-Tag features might be embedded into packaging materials for the merchandise or into the merchandise items themselves.

Licensing Procedure

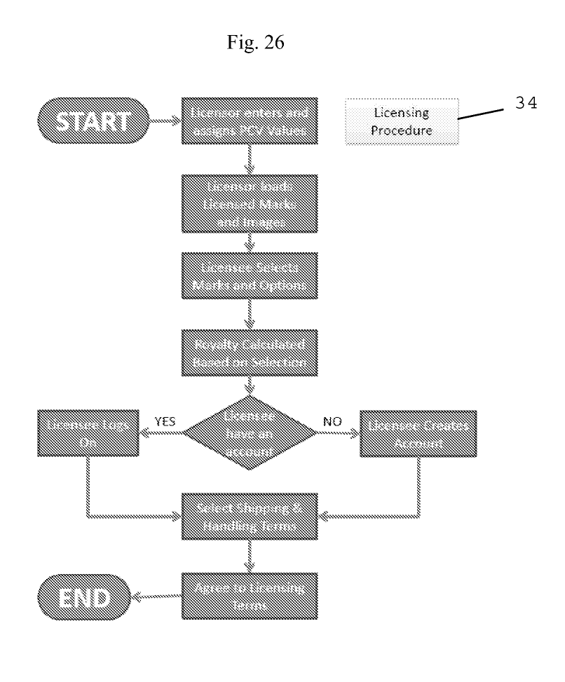

FIG. 26 is a simplified flow chart of the licensing procedure or mechanism 34.

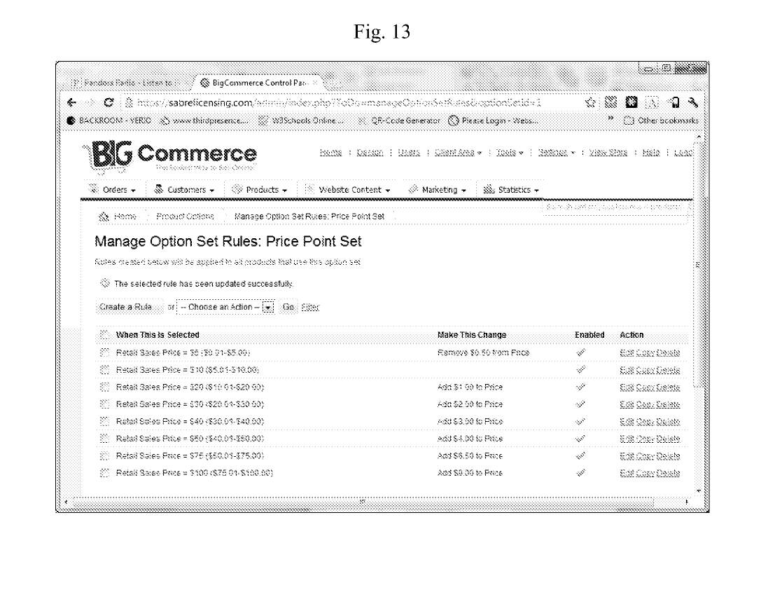

1. As seen in the screen shot in FIG. 13, a licensor or prospective licensor accesses the system. Within Module 2 of the LSP, the Product Category Values which have been entered into Module 1 for a specific licensing category are entered and a specific royalty amount is assigned to the PCVs by the licensor.

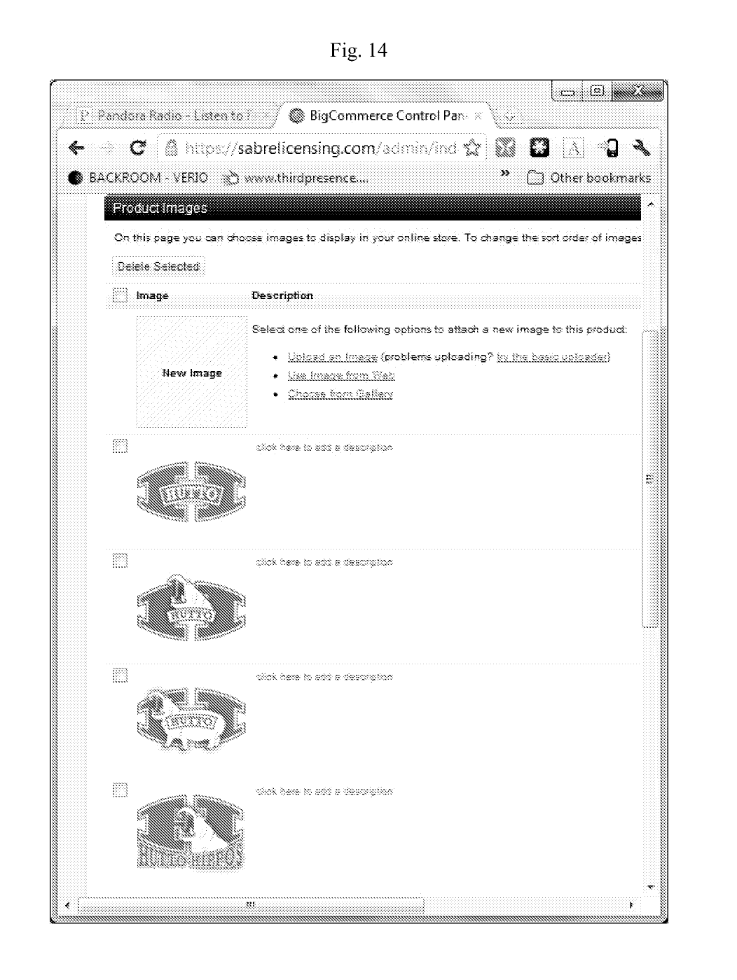

2. As seen in the screen shot in FIG. 14, within Module 2 of the LSP, authorized Marks of the licensor are loaded by the licensor into the LSP in the form of a vector graphic licensing diagram.

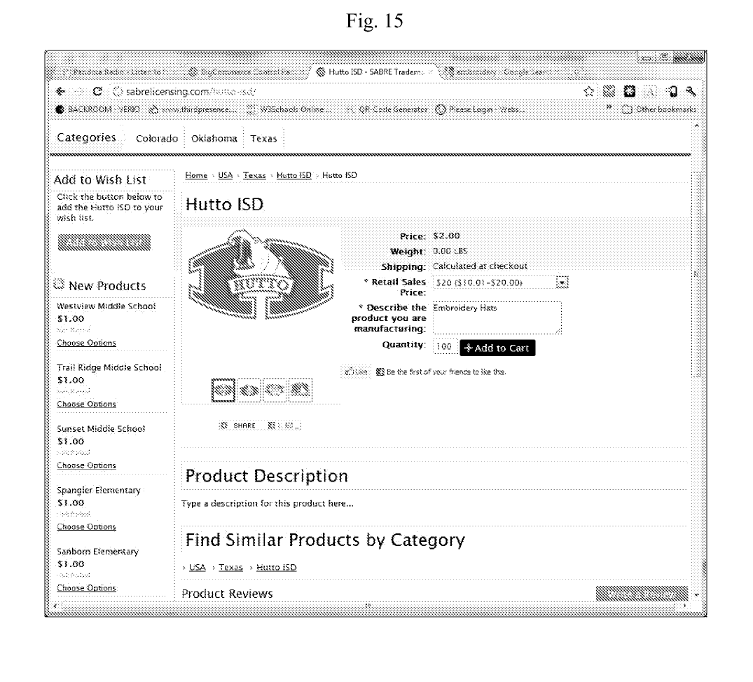

3. As seen in the screen shot in FIG. 15, the licensees log onto Module 2 of the LSP via the internet and choose the Marks they desire to pay royalty on and use on their merchandise. Licensees then enter the PCV level or the maximum retail sale price level which they want to be authorized to sell their merchandise. Licensees then enter the quantity of products they want to sell at each PCV which dictates the number of denominated secure tags or S-Tags they need at each PCV.

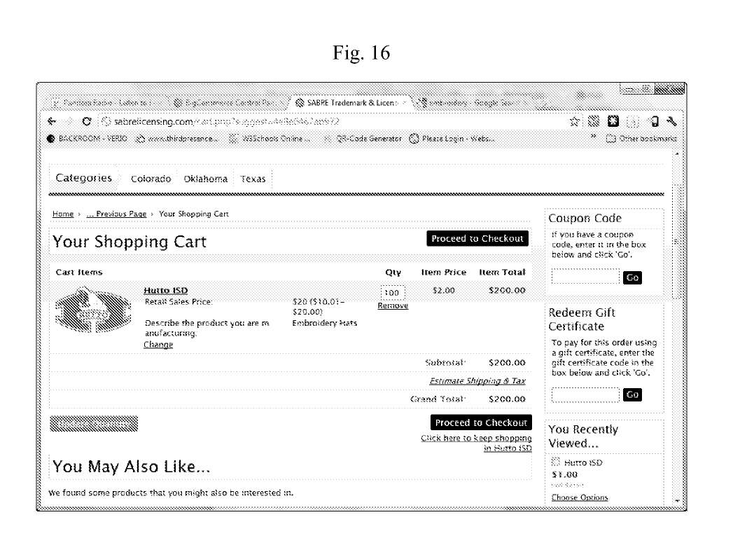

4. As seen in the screen shot in FIG. 16, Module 2 of the LSP then automatically calculates the total royalty owed for the number of S-Tags being ordered at each level of PCV.

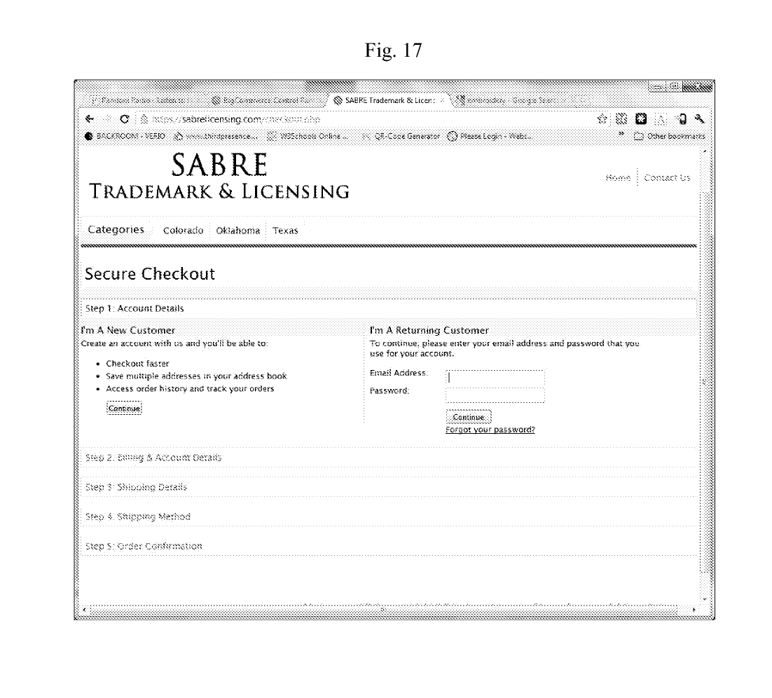

5. As seen in the screen shot in FIG. 17, the licensee then creates a vendor account in Module 2 of the LSP if they are a new vendor or logs onto a previously established account and proceeds to the payment portal of Module 2 of the LSP.

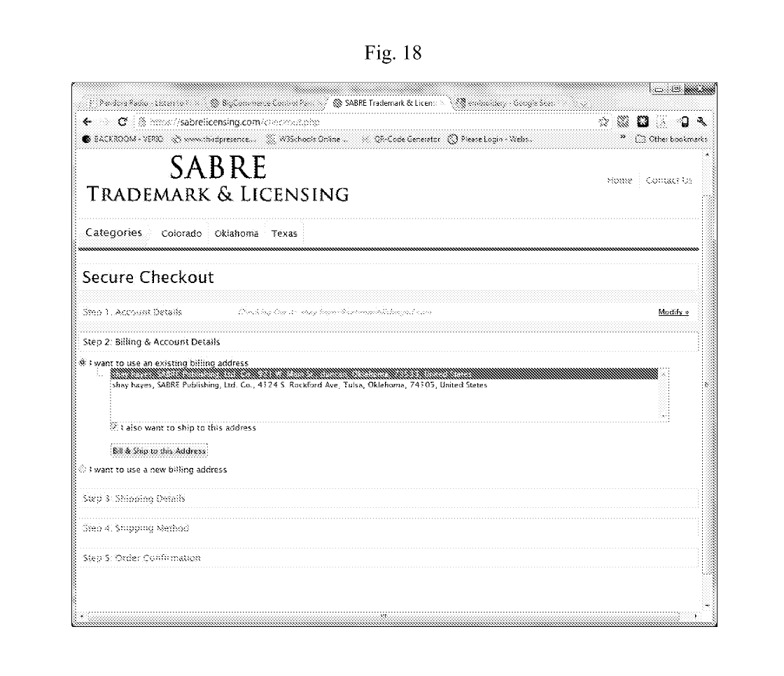

6. As seen in the screen shots of FIGS. 18, 19 and 20, within the payment portal the licensee chooses the shipping and handling terms, the terms of payment (check, credit card, or invoice) and other payment details.

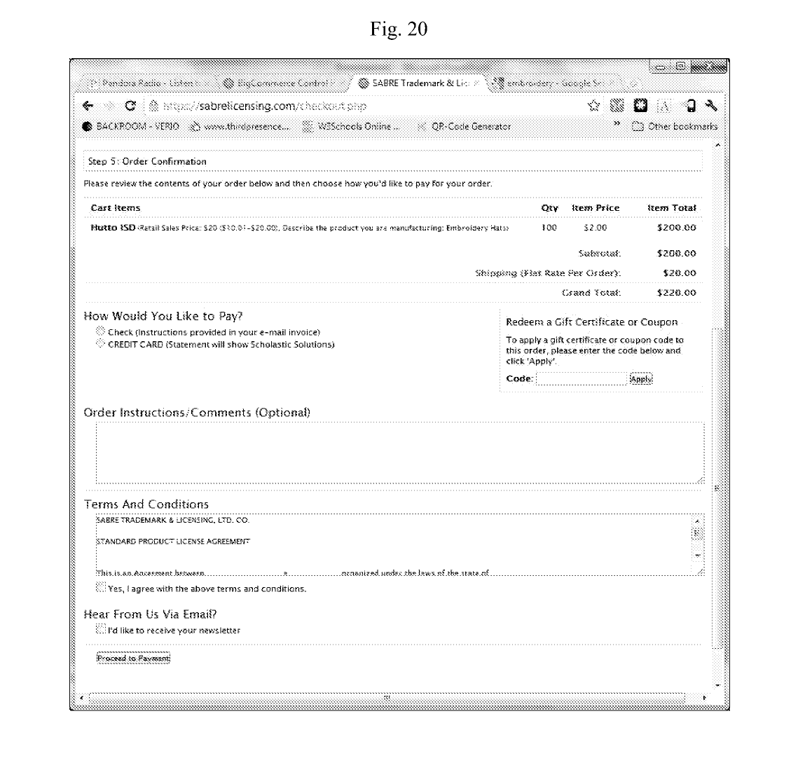

7. As seen in the screen shot in FIG. 20, the licensee must then agree to the terms and conditions of the Authorized Vendor Contract and enter the Authorized Vendor Contract by physically using their computer mouse to check a box consenting to the contract.

Collection Procedure

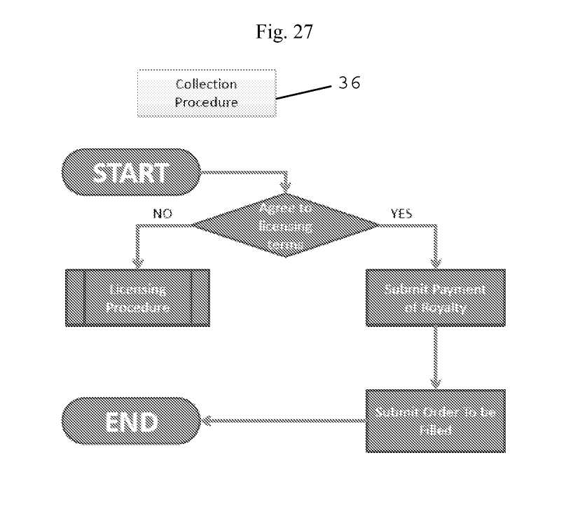

FIG. 27 is a simplified flow chart of the licensing procedure or mechanism 36.

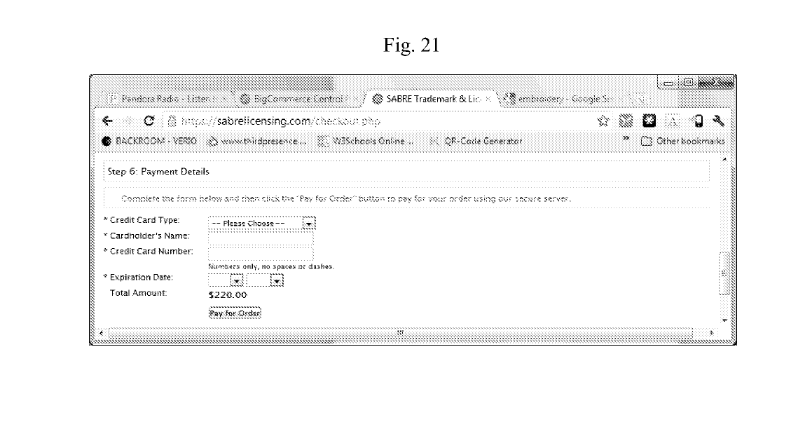

1. As seen in the screenshot in FIG. 21, a licensee who has agreed to the terms and conditions of the authorized vendor contract proceeds to final checkout portion of Module 2 of the LSP to process the payment of the royalty amount via electronic check, credit card, or by generating digital invoices to be received in an email account associated with their account.

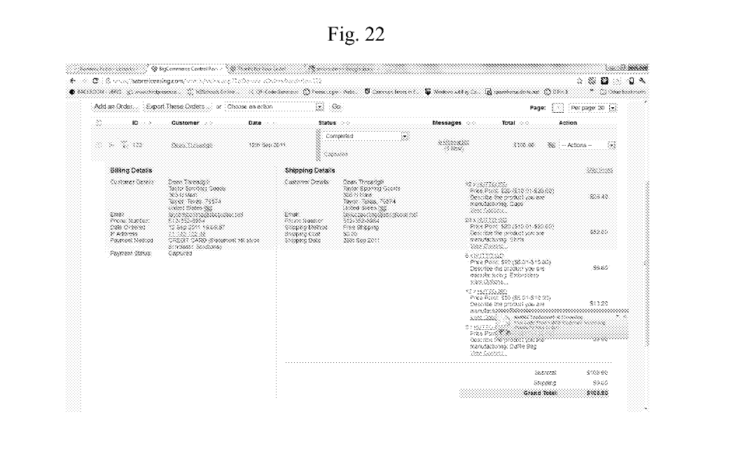

2. As seen in the screenshot in FIG. 22, the software Module 2 of the LSP then submits the order for the S-Tags to the licensor or their agent.

Authentication Procedure

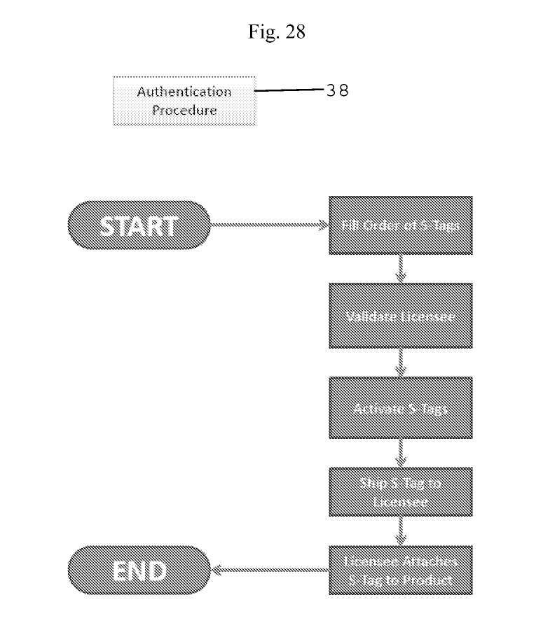

FIG. 28 is a simplified flow chart of the authentication process or mechanism 38.

1. Licensor or their agent then fills the order for S-Tags by pulling from rows of ordered and stacked S-Tags the appropriate number of S-Tags in each denomination.

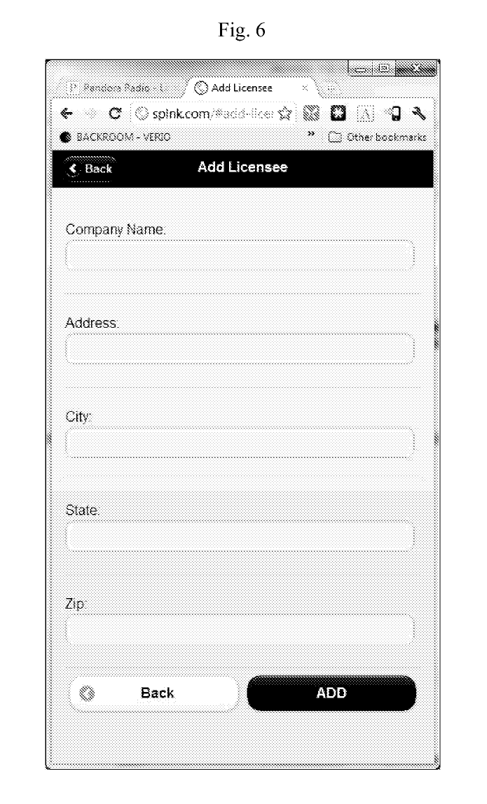

2. Licensor then validates the existence of the licensee (FIG. 6) within Module 1 of the LSP. If the licensee is not available, the licensor will add the licensee to the system.

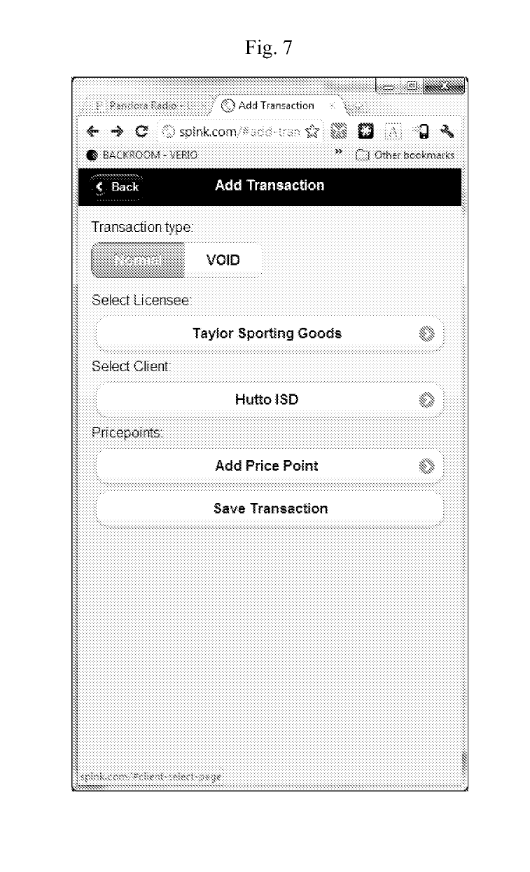

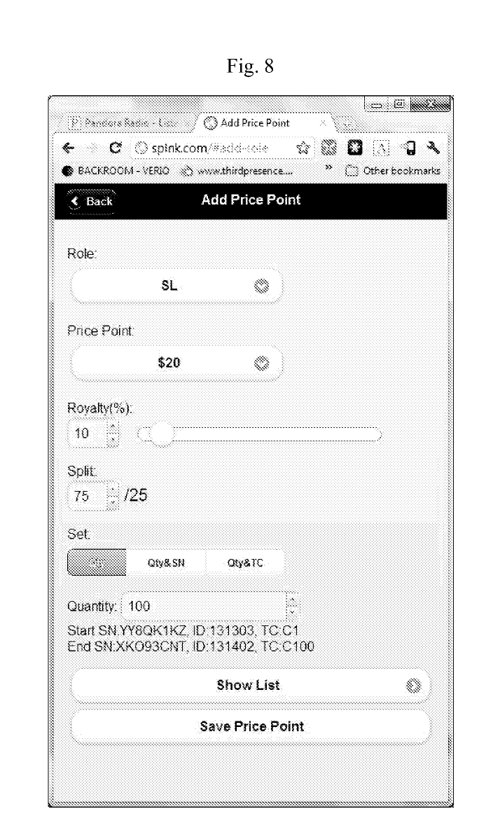

3. Licensor then creates a new (FIG. 7) transaction within Module 1 of the LSP based on the order and enters the following data: the (FIG. 8) licensee information, the transaction details, the licensing category, the relevant PCV's of the order and the starting and ending serial numbers pulled to fill the order.

4. Licensor then ships the order to the licensee.

5. Upon receipt, the licensee attaches the S-TAGS (FIGS. 11 and 12) to the appropriate product bearing the licensor's Marks.

Enforcement Procedure

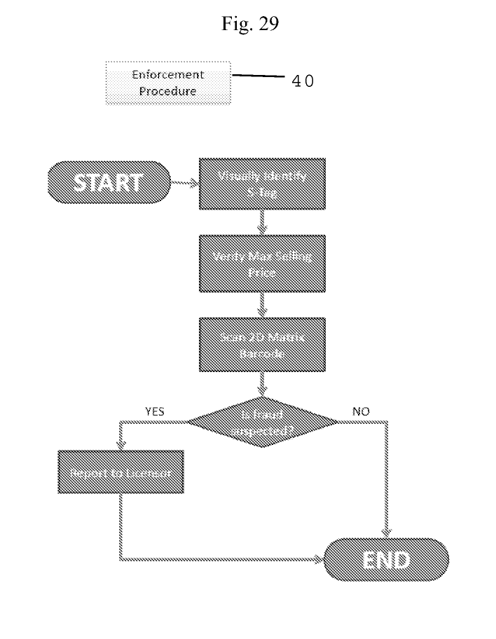

FIG. 29 is a simplified flow chart of the enforcement process 40.

1. When the public (consumers, stakeholders in the licensor, agents of the licensor, other authorized licensees, etc.) view the merchandise for sale they are able to easily identify visually from the presence of the S-Tag (FIGS. 11 and 12) that the merchandise is authentic and they can visually verify based on the denomination that appears on the S-Tag (FIGS. 11 and 12) that an appropriate royalty has been paid for that product to be sold at the particular price.

2. The public can also use a web enabled device (such as a smart phone, I-phone, Droid, Tablet, etc.) to scan the Barcode image on the S-Tag (FIGS. 11 and 12) on the merchandise. This will connect the public via the internet to a website and view the transaction details (FIGS. 9 and 10) associated by the unique serial number directly to that S-Tag. These transaction details (FIG. 8) which were captured in Module 1 of the LSP and linked to that serial number and that S-Tag (FIGS. 11 and 12) will be displayed on the device in a manner that allows the public to verify who owns the Marks (the licensor), the fact that the licensor has authorized the licensee to use the Marks and the fact that the licensee has paid the appropriate royalty amount for that product to be sold at a specific retail price.

3. The public can then simply and easily report any concerns or discrepancies or suspected fraud by clicking on a link (FIGS. 9 and 10) portrayed on the device that provides contact information including a phone number and a report form for the licensor.

The present invention provides a comprehensive process and system to implement and manage the entire merchandise licensing process. In addition, the present invention might be utilized to implement and manage a tax or duty collection process.

Whereas, the present invention has been described in relation to the drawings attached hereto, it should be understood that other and further modifications, apart from those shown or suggested herein, may be made within the spirit and scope of this invention.

What is claimed is:

1. A denominated authenticating royalty collection and enforcement process, which process comprises the steps of:
generating data including creation and assignment of product category values;
manufacturing anti-fraud secure tags for merchandise;
licensing one or more merchandise vendors for said merchandise;
collecting royalties from said one or more merchandise vendors;
supplying said secure tags and authenticating the supply of said secure tags; and
providing a procedure for the public, licensees, licensor and others to authenticate that an appropriate royalty has been paid for a particular product or products.

2. A denominated authenticating royalty collection and enforcement process as set forth in claim 1 wherein the step of generating data includes the steps of:
creating a plurality of said product category values each of which cover a range of selling prices and wherein each of said product category values includes a maximum authorized retail sales price;
creating randomly generated serial numbers; and
generating a plurality of barcodes, each barcode associated with one of said randomly generated serial numbers.

3. A denominated authenticating royalty collection and enforcement process as set forth in claim 1 wherein the step of manufacturing anti-fraud tags for merchandise includes the steps of:
affixing an anti-fraud device to a tag; and
associating a randomly generated serial number with a barcode and a denominated dollar amount on said tag.

4. A denominated authenticating royalty collection and enforcement process as set forth in claim 1 wherein said licensing one or more merchandise vendors includes the steps of:
entering said product category values for a specific licensing category and specific royalty amounts by a licensor;
preparing a diagram of authorized trademarks for licensing by the licensor;
choosing marks for licensing and product category values by a licensee; and
calculating a royalty for secure tags to be ordered at each level of product category value.

5. A denominated authenticating royalty collection and enforcement process as set forth in claim 1 wherein said procedure to authenticate includes the steps of:
visually identifying an s-tag on an item of said merchandise and a denomination on said s-tag;
connecting to a website to view transaction details associated with a unique serial number for said merchandise; and
reporting any concerns or discrepancies via said website.

6. A denominated authenticating royalty collection and enforcement system, which system comprises:
a data generation mechanism including creation and assignment of product category values;
anti-fraud tags for merchandise including said product category values;
a licensing mechanism for one or more merchandise vendors for said merchandise;
a royalty collection mechanism from said merchandise vendors;
a merchandise tag authentication procedure; and
a public mechanism to authenticate that an appropriate royalty has been paid for said merchandise.
